(19) United States
(12) Patent Application Publication
(10) Pub. No.: US 2024/0318639 A1
(43) Pub. Date: Sep. 26, 2024

(54) Energy Production from Deep Ocean Pressure

(71) Applicant: Stirling Industries LLC, Honolulu, HI (US)

(72) Inventor: Stirling T Hebenstreit, Honolulu, HI (US)

(73) Assignee: Stirling Industries LLC, Honolulu, HI (US)

(21) Appl. No.: 18/426,302

(22) Filed: Jan. 29, 2024

Related U.S. Application Data
(63) Continuation-in-part of application No. 18/046,334, filed on Oct. 13, 2022, now abandoned.

(51) Int. Cl. F03G 7/04; F03G 7/00

(52) U.S. Cl. CPC F03G 7/04; F03G 7/0252

(57) ABSTRACT

Positive deep ocean pressure acts as force upon a containment being the negative pressure area for which water may first enter under force. The containment and apparatuses which allow energy production to occur are lowered to a specific depth within a body of water from a floating platform (Ref 40) or water vessel, then anchored by the systems own weight that may be between 30,000 and 40,000 pounds, or less when used in conjunction with water ejectors. The energy system may be hung at a specific depth within the body of water and will make continuous energy for use as electricity by; 1) utilizing the naturally occurring pressure at various water body depths, 2) applying the pressure through electrical generating devices, 3) provide for an internal pipe pathway and expandable water bladder or solid pressure tank that maintains a specific pressure necessary to return the water to the body of water after overcoming the naturally occurring pressure due to the ocean depth, 4) Ensure all Marine Mammals are Protected, 5) Embody a series of subsea cables (Ref 41) Several alternative primary modes are described beyond FIG. 1, by FIG. 2, FIG. 3, and FIG. 4. FIG. 2 provides for a combined intakes which increase volume and pressure before allowing velocity to return water flow to the water body, while FIG. 3 embodies water ejector pressure (Ref 38) to increase water velocity to return water to the water body. FIG. 4 embodies a similar process as FIG. 1 and FIG. 2, but also includes gravitational force to make additional energy before returning water to the water body. The conservation of fluid flow states; inflow always equals outflow (Ref 39).

### CROSS-REFERENCE TO RELATED APPLICATION

This application is based upon and claims the benefit of U.S. patent application Ser. No. 18/046,334, filed on Oct. 13, 2022.

### TECHNICAL FIELD

The disclosure relates to the production of renewable energy and the application of physics to the production of energy which can be scaled to conform with present net zero carbon industrial electrical demands for developed and developing nations. This disclosure relates to systems that utilize hydro kinetic energy production from naturally occurring deep ocean pressure. The present invention further provides for a reduction of CO2 emissions by virtue of offsetting present carbon emissions from all sources and thus addresses global warming, e.g. where low lying coastal regions are threatened by climate change and associated sea level rise.

Because a naturally occurring pressure exists as a constant force due to any deep water body of water varying ranges in depth, a mechanical device that extracts water's stored potential energy can be applied to generate an electrical current.

### BACKGROUND OF THE INVENTION

The renewable energy sector is in-part presently represented by solar panels, concentrated solar, wind farms, bio-waste, hydropower, and ground thermal heat pumps These are excellent examples on how far along the sector has come. Nuclear energy can also be implied as renewable energy when plutonium and uranium rods used to generate heat are repurposed. However, repurposing does present well known health risks to workers, environment and is also energy intensive. Energy intensiveness is a key factor in other climate change carbon reduction processes, e.g. Direct Air Capture (DAS), the process that captures atmospheric carbon from the air (Ref 46). Furthermore, Carbon Capture Storage (CCS) is an energy intensive process (Ref 47). A need for cleaner and more efficient renewable energy sources for CCS and DAC which overcomes increased energy costs can be represented by the present invention's novelty approach. The present invention by producing a large amount of energy (Ref 27) could co-exist with the present renewable sector to supply consumer, commercial and industrial energy sectors further benefiting the application of AC and DC interconnection for regional power utility grids that power commerce and business. Furthermore, in an era of energy efficiency, increasing energy demand and conservation, renewable energy does require(s) large areas of land, often affecting wildlife habitat which can lead(ing) to a degradation of trust within communities and environmental groups worldwide. The recent reinvention of the use of Hydrogen, referring to Green hydrogen fuel cells (Ref 48) that utilize the abundance of seawater are also mentioned here.

The loss of general land aesthetics and degradation of land from both solar and land wind farms can be attributed in-part by up to 80% of sensible heat loss to radiative forcing effect (Ref 49). Wind farms could attribute to 0.24%, or ⅛^{th} of global warming (Ref 50). Solar energy recovery at best is just 25% efficient, while wind achieves 10% to 50% when operating. Solar operates best in cooler climates but is less efficient when covered with snow, ice or rain, all being factors that lead to further reductions in efficiency. Solar operates only during the day, unless tied to an energy storage battery bank. No renewable energy technology is net zero (Ref 23) and to imply otherwise is almost impossible because each requires some type of mineral, mining process or implementation process, and for each mentioned does in-turn require some form of energy to make. The mining of minerals used for conducting electrical currents like copper, aluminum and silver, for example, are part of a necessary energy train that provides the end energy user with essential electricity. There is also an energy slave who is required to mine the mineral or resource, as in cobalt mining for the manufacturing of electric vehicle batteries. Green hydrogen, like the present invention, requires an energy train and energy slave, but by virtue of its clean energy production methods FIGS. 1, 2, 3, 4, fewer energy slaves are employed than with the mining of cobalt or lithium ion. The result of fewer energy slaves and energy trains is as near to Net Zero as is currently obtainable. Hydropower is an excellent high efficiency energy. Therefore, hydro-kinetics (Ref 51) was chosen as the primary mode (Ref 52) for the present invention further disclosing the use of, in conjunction with water's stored potential kinetic energy, to make available a high energy efficiency of up to 90% from the ocean and other renewable energy resource of a water body when the apply apparatuses and devices to produce critical electricity through the primary modes continuous process. Furthermore, the primary mode is adaptable to present technology (Ref that can better scale global carbon offsetting from clean energy production (Ref 53). The conservation of energy and environmental preservation of our planet are best practices to maintain a necessary balance; in-part, being our earth's finite resources, to further consider how we resolve, reuse, and recycle, at best, avoiding future incidental biological dispositions and environmental failures that can lead to extinction and human discomfort. The present invention relies on having a physical presence far from land, or in a near coastal or lake environment, and because the invention is below water body surface, the mechanics are largely out of sight and thus removed from urban populations while remaining in a close proximity to the electric service power grid. An 8-15% power loss is one consequence of overground electric line transmission (Ref 54). Therefore, the invention provides for close proximity to major populations, while providing for AC and DC interconnections. Finally, the addition of a marine protection zone is included with (FIG. 2). Nuclear power is posing a greater risk to humankind from the core materials itself, and the possibility of a reactor meltdown, while the spent rods require long term storage posing more challenges (of) for reuse of table of elements 239 and 236. More threatening yet is when this technology is associated with a war zone as is being seen in the Ukraine when a cooling reactor turbine has no primary core power supply, a secondary form of power, quite often diesel fuel because of its respective power ratio return, becomes the immediate back-up energy source. Chernobyl and Fukushima are examples of how seawater is absolutely essential to large ongoing cooling processes. Although we may not see the end of Nuclear power, we are more aware of the detrimental consequences it poses to our world. A recent adaption of Nuclear power can be seen by its application as a small medium reactor (SMR's), (Ref 55).

### SUMMARY OF INVENTION

The invention relates to the production of a renewable energy being sourced from a deep ocean, near coastal, inland natural lake, or man made inland lake, presented here as unique potential renewable energy sources because of a naturally occurring positive pressure existing at various depths within a body of water's column. Pressure can be defined as an element of force (Ref 56) which the present invention embodies through the water flowing under a constant positive force being applied to a deep water structure containing apparatuses and mechanical devices which provide a means for utilizing water's stored kinetic potential energy which can be harnessed by a mechanical device which makes an electrical current. This primary mode of energy production presents opportunities to further expand the growing global renewable energy sector that includes solar, wind, nuclear, bio waste, and hydro-electric dams, some of which are limited in their efficiency for overall net energy returns after a renewable energy investment (Ref 30) or by environmental and large amounts of land associated with their use (Ref 29).

Climate Change is now a well-established reality whether man-made or otherwise, while the severity of natural disasters and the failing of large Hydroelectric Dams (Ref 57) is also a well known reality, as is the destruction of seasonal fish runs due to the implementation of Hydroelectric Dams. As climate change affects snow melt and global temperatures rise, the possibility of high altitude water run from snow melt to rivers that make hydroelectricity, may become a concern. Furthermore, the warming of oceans (Ref 58) from climate change intensifies the severity of Hurricanes. The present invention offers small developing island nations whose electrical power grids have been disabled by storms (Ref 15) an alternative energy supply based entirely beneath the water surface where wind sheer is not applicable and turbulence on the seafloor is less (Ref 16). The present invention deep ocean energy production system in this case could be applied in conjunction with subsea power cables (Ref 41) and shoreside energy storage battery banks (Ref 21). In this embodiment, the 4 figures (illustrations) represent the energy system operating at depths ranging from FIG. 3 of 100 ft, to FIG. 1 and FIG. 2, FIG. 4, of 560-600 ft, but could be applied to a greater water depth. The depths benefit where Hurricanes are most destructive (Ref 17). Hurricane Maria on Puerto Rico (Ref 18) resulted in 90% destruction of the power grid and a loss of over 3000 lives. In a case like Hurricane Maria or other destructive Hurricanes and Typhoons, the present invention has a potential to produce energy far below the water surface where Hurricanes are less destructive (Ref 16). Furthermore, a deep ocean energy production system could be applied to fast recharging of energy storage battery banks (Ref 19) to assist with recovery efforts when a disaster like Hurricane Maria strikes. An example of how energy storage restores power can be seen by (Ref 32). Furthermore, green hydrogen power by renewable energy (21) can be more environmentally friendly and cost advantageous to lithium mining. In an era of rising global temperatures and concerns for reducing carbon emissions by means of offsetting (Ref 20), the present invention will offset carbon emissions by 500,000 tons annually (Ref 11) when a single 1.67 megawatt system is operating continuously and produce 875,000 megawatt hours annually (Ref 27). Furthermore, the energy system can be mobilized from one area of a water body to another. When compared to wind and solar, the present invention's primary mode being deep ocean energy production operating at 90% turbine efficiency will output 3.6 times more energy than solar, and 1.8 times than wind. Solar is 25% efficient when converting the Sun's 1000 watts per square meter irradiance (Ref 22) which relies on peak sun hours (Ref 28) and large areas of land (Ref 29) to be most productive. The capital cost of solar panels when compared to the cost of deep ocean energy return as a capital cost and return on energy investment is referenced by (Ref 30). Wind farms rely on geographical location for a power factor (Ref 13) of 50% according to the Betz limit. The present invention could operate in deep ocean, near coastal, estuary, bay, inland lake, or deep harbor, as an open loop process, or man-made water body (closed loop). The goals of reaching net zero are defined by the Paris Agreement (Ref 24).

If asked how this or the next generation solves energy conservation, one answer might be: less means more, and by less land use, transmission line hauling, a greater return on energy investment, and energy production efficiency, a fair and equitable energy pricing, the invention seeks to help resolve this present era of global conservation. By considering more conservative and efficient energy technologies in an era of conservation and carbon reduction offsetting, mankind better aligns to overcome the adverse effects of global warming. By denying progress for mankind, the threat of a progress stalemate increases due to the risk of in-action.

The invention's implementation cost could achieve a $3 million installation cost. A hydropower system of the embodiment has a cost of US$1.6 million. A US$1.4 million appropriation assumes remaining project costs, but may be more or less. The area of seafloor to operate a 1.8 MW system requires an area of 600-1000 square feet. A surface platform further described herein would allow for both AC and DC energy load demand to be monitored and transferred that induce further operating costs, onsite engineers, service professionals and onsite power monitoring technology. A similar energy supply sourced from a utility scaled solar farm that uses solar panels from China costing of $0.15 per watt (Ref 35) would require 589 acres (Ref 29) of land when compared to 600-1000 square feet for the present invention, and require a 3.4 peak sun hours (Ref 28) per day over 365 days to produce this inventions equivalent of 875,960 (×0.90%) megawatt hours. Furthermore, the present invention could operate both day and night for faster returns on investment and could possess greater opportunity for global implementation because of shorter line haul distances (Ref 34). An example, in the Pacific Northwest's Puget Sound where depths of 560-600 ft are common, multiple near shore locations being 1,200 yards from a close proximity major shipping port and electrical grids, as in the Port of Tacoma in Pierce County Washington (Ref 35) are presented herein. Because close proximity is essential for short distance line haul and reducing energy distribution losses, DC energy storage is a secondary application for the primary mode to deliver energy to markets. Furthermore, by example, a single 1.8 MW deep ocean energy production system having 1,670,000 watt continuous output (Ref 25) positioned at a depth of 560 ft of water and 1,200 yards (3,600 ft) from the nearest shoreline, could interconnect with AC electrical transformers and utility service providers providing a low cost, consistent, carbon free AC and fast recharging DC energy storage energy technology for companies intending to provide electric markets with an alternative business model, i.e., DC energy storage residential, commercial and industrial businesses. The invention being mobile (FIG. 2) could allow global DC energy scaling that meets Paris Agreement NetZero expectations while offering a comparative energy source and competitively priced energy source in conjunction with making the benefits for energy consumers advantageous by meeting the rigorous demands of climate change and concerns for environment. In this way, the invention approaches a future generation's wellbeing.

A well designed ocean energy production system that coexists with a vast, still untapped ocean energy potential presents a long term benefit for our present planet's challenges. A question to consider may well be: are we prepared to challenge an accepted often obscured pre-position which can further lead to a societal disposition of what progress for mankind represents? The answer would seem to be a resounding “yes”.

The proposed benefits from deep ocean energy production are: 1) generate an alternating current electrical power in close proximity to high density populations, 2) provide a means for faster charging of energy storage batteries, 3) lower by of set global carbon emissions from all sources by applying a renewable energy resource by up to 500,000 tons per system per year (Ref 11), 4) produce up to 789,750,000 kilowatt hours per system per year (equivalent to powering up to 75,214 homes at 10,500 kWh per home per year (Ref 27), 5) produce an affordable (Ref 34) globally scaleable energy source which is up to 90% efficient from a renewable readily available hydro kinetic energy source, 6) anticipate a supply cost of $0.000025 cents per watt based on $25 per megawatt hour; please see power purchase agreements (Ref 33), 7) adapt to an increasing global energy demand, 8) scale a comparative renewable energy technological being cost competitive for everyday business models; i.e. home and building energy demand and industrial processes, 9) provide a continuous cycle primary mode at various depths of a water body's column to generate electrical power, 10) apply a recharging station medium in the offshore, near coastal, or lake environment to re-power battery ships (Ref 45) that operate short and long distances (FIG. 2) while reducing a ship's carbon footprint and avoiding high costs of refueling in foreign ports, 11) produce energy below the surface during a hurricane, or below ground in a closed loop process during tornadoes, 12) scale a transport and delivery of energy storage battery systems across the high seas, inland waterways and major thoroughfares.

### BRIEF DESCRIPTION OF DRAWINGS

FIG. 1 shows an embodiment of an ocean pressure generator of the disclosure.

FIG. 2 shows another embodiment of an ocean pressure generator of the disclosure.

FIG. 3 shows another embodiment of an ocean pressure generator of the disclosure.

FIG. 4 shows another embodiment of an ocean pressure energy generator of the disclosure

### DETAILED DESCRIPTION

The disclosed systems are adaptable to present day business models used by the offshore oil industry, and in this way can be applied universally, as an adaptable technology process for oil platforms being decommissioned or similarly in conjunction with an offshore wind farm type floating platform (Ref 26). Shared Technology for comparative/competitive advantages in the energy sector progress a net-zero smart grid by a universal application. National oil and gas reserves can be further quantified when the technology is allowed to service the national electrical grid demand from building sector of 70% (Ref 34).

The invention presents a novel approach for continuous clean energy production offering a sufficient amount of power from a single deep ocean energy production system to power 83,362 homes (Ref 1) for AC electrical grid interfacing and DC energy storage that offset global emissions by 500,000 tons per year per system.

Using Fluid in a Horsepower formula (Ref 3):
PSI×GPM/1714=242 psi×17954/1714=2,535 hp, (745 watts=1 Hp); so, 2535×745 992,635,020,000 watts hours/1000 watts per kilowatt=992,735,020 kWh, or 992,735 Mwh. This is equivalent to powering 94,537 homes. Kilowatt or similarly Megawatt hours are a summation of total power produced over a full calendar year which is equivalent to 8760 hours (Ref 15). By example, a 1.88 MW hydro powered generator (Ref 25) will operate at a 0.875% efficiency and deliver 1.67 MW (1,661,839 watts) as power per minute, or the equivalent of 873,463 MWH per year when operating continuously. Cooling will occur by natural thermal conductivity from the water of body. Temperatures at the operating depth of 560-600 ft are 4 degrees Celsius (Ref 36).

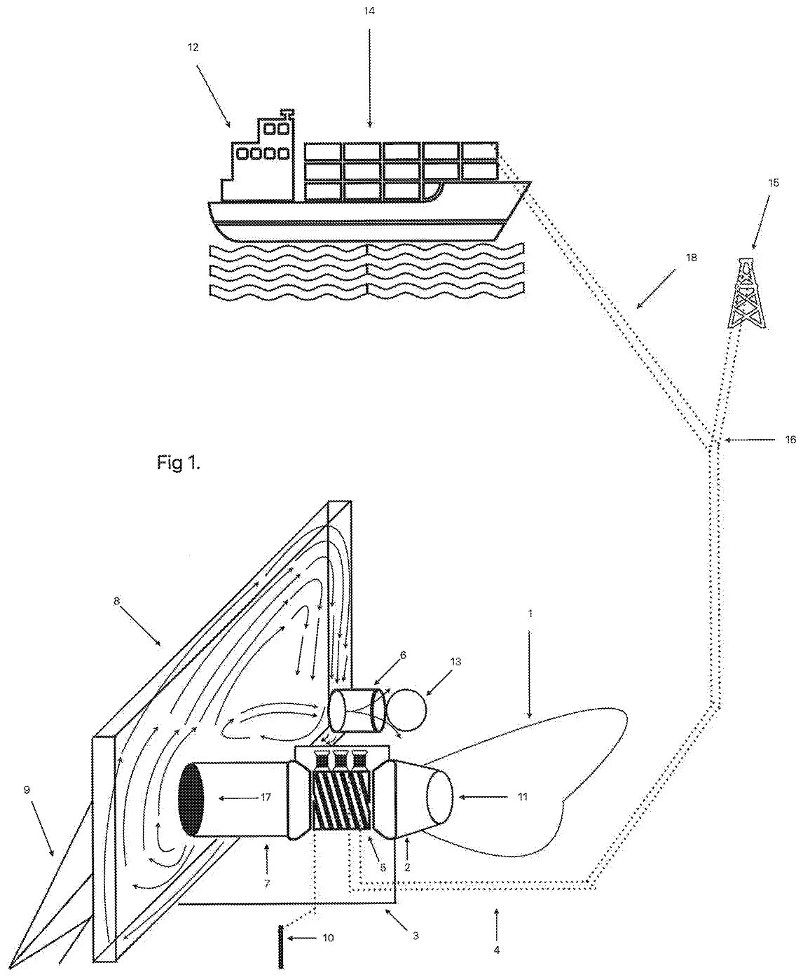

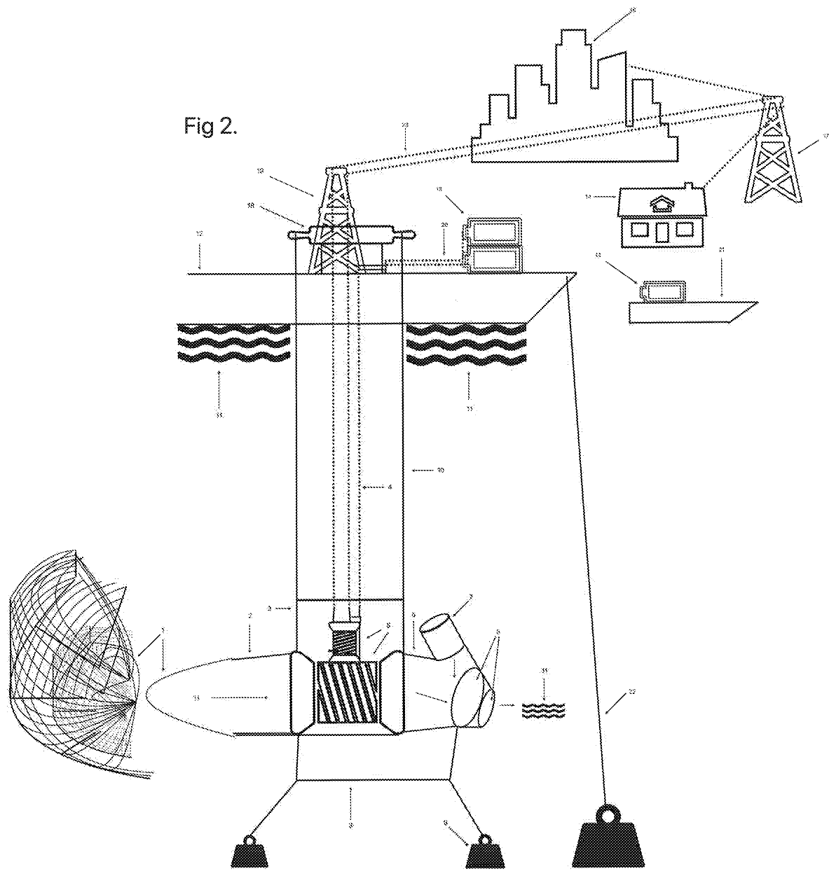

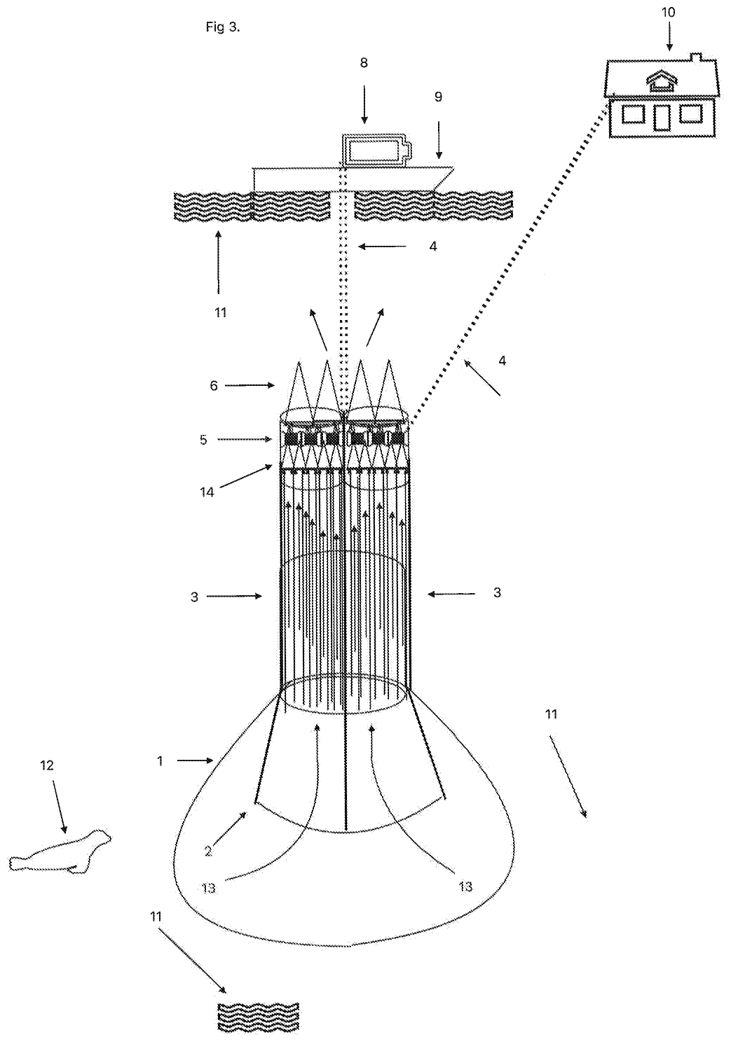

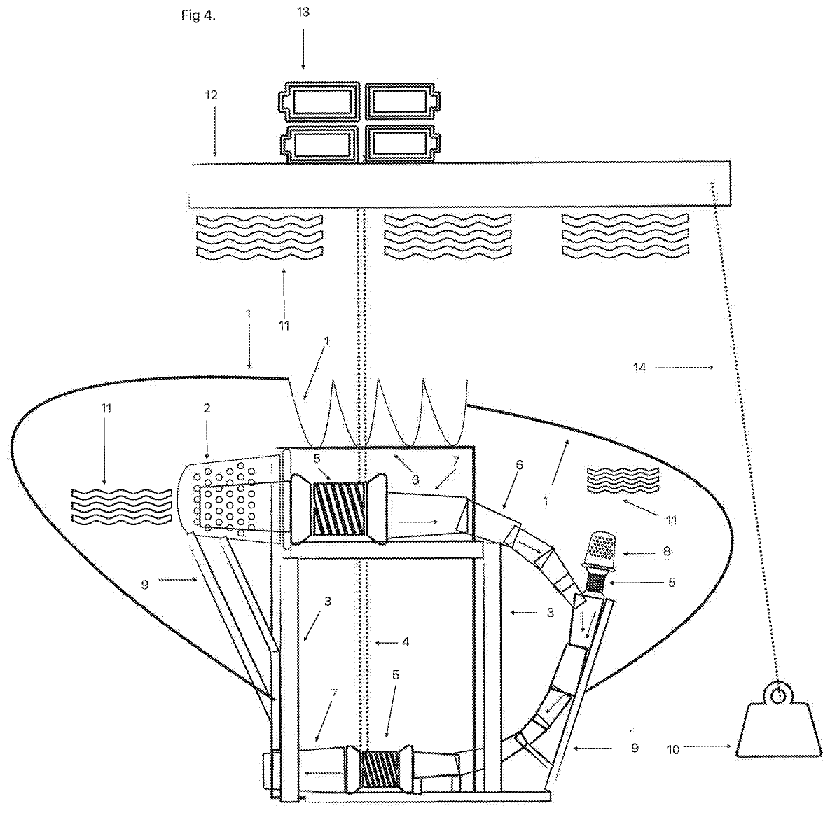

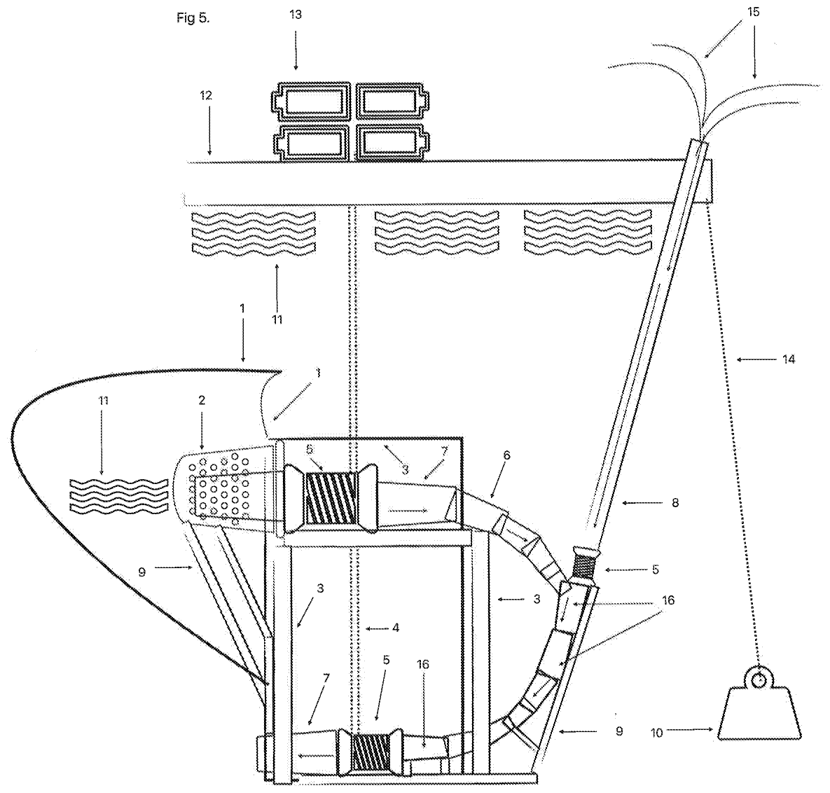

Described further herein as the primary mode, a sealed enclosure (3) shown in FIG. 1, FIG. 2, FIG. 3 and FIG. 4, may embody a minimum HY 80 grade steel to withstand a deep ocean naturally occurring pressure, is permanently placed on, or near the bottom terrain of a body of water (11), which may be either fresh, or salt. The enclosure (3) provides for electrical conducting equipment (4) and other essential devices and apparatuses (5), relating to power generation specific to this invention's embodiment. An enclosure (3) containing energy production apparatuses (4) and (5) and other essential devices for conducting electricity may be lowered from a floating platform (12) as is shown in FIG. 2 and FIG. 4, and submerged in a body of water (11), in this example, the depth of water is between 560-600 ft. The enclosure (3), containing apparatuses (4)(5) and other essential electrical equipment will open an air actuated intake from the surface platform (12) to allow water to flow, whereby making advantageous the reoccurring body of water's naturally occurring pressure of (11) to make clean ocean energy production permissible. Power generation from (5) is made concurrent through an electrical current (4) by the positive force of water entering (2) having a positive pressure (11) which when exerted upon (5) being a turbine generator which is made to rotate under pressure inside (3) and further being hermetically sealed, will produce an electrical current (4). The electrical current can be applied to fast charge energy storage battery banks, FIG. 1, (14) FIG. 2 and FIG. 3, (13), FIG. 3 (8) which can be transported FIG. 1, FIG. 2, and FIG. 4 (12), FIG. 3 (9) to supply a close proximity DC FIG. 1 (14) or AC FIG. 1 (15) electrical power load. The primary mode in FIG. 1 can be simplified by a sequenced process being: (11) (2) (5) (7) (17) (8) (6) (13) (11).

The primary mode in FIG. 2 can be simplified by a sequenced process being: (11) (2) (5) (6) (7) (8) (11).

Further simplified, water being under constant pressure by (11) will first enter the enclosure (3) through intake (2) before water's stored potential kinetic energy is converted to mechanical energy by (5) making an electrical current (4).

FIG. 1 describes the primary mode as continuous by water being returned to the water body (11) by (17) being a turbine generator tailrace pipe, to (8) a pressure tank, which allows (6) being a reduced pipe having (13), a pressure plate which opens upon a water weight of 7,179 pounds of seawater, or similarly 860 gallons of water which having filled (8) after a 2.89 second period. The flow rate from (11) and further represented by (Ref 25) is 40 cubic foot per second, or 299 gallons per second. Thereafter, FIG. 1 (8) maintains a constant pressure of 860 gallons by a constant 40 cubic feet water path from (11)(2)(5)(7)(17) to (6) being a reduced pipe which allows (13) being a pressure door to open and return water at 282 psi to (11). In this example, (8) has a dimension of 115 ft3 (1550 in2). The pressure tank (8) is adequate and necessary to build enough pressure after losing a minimal amount due to pipe friction (Ref 13) when passing through (2) (5) (7) and (17) before entering (8). (10) describes an electrical grounding rod, (16) describes a DC/AC junction box, (18) describes a DC conductor.

Furthermore, using FIG. 2, a ship or surface type platform (12) which embodies an AC (4) submarine cable which connects to (19) for AC distribution (23) to a land-based tower (17) for onshore power loads (14) (16). DC energy storage is represented by (13). Furthermore, the energy storage (13) is given mobility by a motor vessel (21). The platform (12) may be moored (22) or embody an anchoring arrangement (9) or be dynamically positioned. The more cost effective solution would be moored to the seafloor by anchors (9) or purposed in conjunction with an electric or similar type tug (21) which holds the platform (12) in a dynamic position above the energy production system (3). (5) is a turbine generator, (6) and (7) are part of the tailrace piping arrangement that returns water through (8) a reduced pipe to (11). (1) describes a marine protection type arrangement.

### Formulas:

Using Fluid in a Horsepower formula (Ref 3):
PSI×GPM/714=242 psi×17954/1714=2,535 hp, (745 watts=1 Hp); so, 2535×745=992,635,020,000 watts hours/1000 watts per kilowatt:=992,735,020 kWh, or 992,735 Mwh. 992,635,020,000 watts hours are the equivalent of powering 94,537 homes. Kilowatt hours are a unit measurement used over one full calendar year, or 8760 hours.

The primary mode, or sequence described further herein, is made continuous for FIG. 1, by water being returned to the water body (11). By example, FIG. 1 may represent a total of 7,179 pounds of seawater which would fill (8) after 2.89 seconds of continuous water ingress from (11) at a flow rate of 40 cubic feet per second. After (8) has been fill in 2.89 seconds, (8) will fill and every second from a 40 cubic feet per second volume to pressurize (8) before water is returned under a pressure of 282 psi due to the reduced sized pipe at (8) and the larger pressure building pipe (6). A larger size pipe allows pressure to be built (6) while (8) being a reduced size pipe allows for increased velocity to (11).

### Primary Mode Sequence FIG. 1

FIG. 1: A high pressure plastic pipe or new steel can be used for (2)(6)(7). The primary mode being continuous is summarized through the following sequence: (11) (2) (5) (6) (7) (8) (11)

The Primary Mode is made continuous and requires 282 psi inside (8) before exiting at (6) and (13). The tank size of (8) is determined by (Ref 9)
P=Pressure (282 psi)
F=Force (443,724)
A=Area (1,550 in2)

The Required pressure of (8) which will pass through (6) at 282 psi can be explained as:
Pressure=1973686 Pascals which=282 psi Ref (8)
Divided by 4.448 (Force Newtons)
Force:=443,724 N/m2
Divided by Area in square inches
Area=1,550.074 in2 (Ref 9)
PSI=282 psi.
1973686/4.448/1,550.07=: 282 psi

A shorter internal path (2) (5) (7) creates less friction for water. Ref (13)

Diameter Pipe=40 inches, Length of (2) (5) & (7) is 11 ft, Pipe is New Steel.

Kinetic Friction reduces (Ref 13) by 0.005961118235398289 per meter of pipe (2) (5) & (7) 11 ft of pipe=3.63 meters; 3.63×0.005961118235398289=0.021655317235595 of pipe friction.

### Primary Mode Sequence Fic 2

The primary mode in FIG. 2, being continuous is summarized by the following sequence: (11) (2) (5) (6) (7) (8) (11), which applies velocity as pressure at (8) by combined additional water flow from (6) and (7) to return potential stored water to (11).

FIG. 2 uses Formula; P=M×A which describes velocity to solve for kinetic friction within the primary mode made by naturally occurring pressure due to depth (11), which in this embodiment involves a depth of 560-600 ft, or 242 psi (Ref 1)

Where:
P=Pressure, M=Mass, A=Area
To calculate the required Velocity required by FIG. 2 at (8) please refer (Ref 4).

In the primary mode examples of deep ocean energy production, a water flow rate of 18,000 GPM (gallons per minute, or the equivalent of 300 gps) first enters (2) under a constant pressure of 242 psi from (1i) at a depth of 560 ft. A pipe diameter (2) is 3.65 ft, and the pipe length is 3 ft. A 40 cubic feet volume is necessary for (Ref 25) to make use of water's potential energy. Pipe friction loss is negligible.

### Referring to FIG. 2.

The primary mode is continuous allowing for constant energy production when the pipe surface area of (8) is allowed to build pressure from pipes (6) and (7) before velocity is achieved to overcome kinetic friction of 242 psi naturally occurring by (11).

This is partially achieved by (Ref 37) being velocity applied as pressure by (6) and (7) at (8) Without a reduced pipe, velocity would be constant through (2)(5)(6)(7)(8). By pipe reduction an increase in velocity (Ref 4) (Ref 37). Similarly to FIG. 1, the primary mode must overcome the pressure of (11). This is achieved by:

Pipe (6) FIG. 1, having a 3.65 ft2 inside diameter and a 3 ft length with a drop pressure of 560 ft or 242 psi (Ref 4).

Its water velocity is 26,303 cubic feet per second (Ref 4), (Ref 7).

Furthermore Pipe (6) also having a constant 242 psi can be expressed as Pascals:
Pascals=1669000, (242 psi) (Ref 8).
Mass=1265-1300 Kg/m3 at 4 degrees Celsius
The Velocity=603 ft/s (Ref 4) (Ref 7)
The Mass=1030 Kg/m3 at 4 degrees Celsius
Pipe labelled (7) has a 1.3 ft inside diameter and 4 ft length Ref (4),
Its water velocity is 603 ft/s. (Ref 4)
Pascals:=1665372 (241 psi)
The water Mass=98.6 Kg/m3 at 4 degrees Celsius
The Velocity=603 ft/s (Ref 4) (Ref 7)

Bernoulli equation (Ref 37) can be applied to FIG. 2, for a constant pressure passing through from (11) through (2) (5) (6), where a combined reduced pipe (7) further increases velocity at (8) by ejectors (Ref 38) in FIG. 3 which further are designed to increase pressure as pascals before reentering (11). The result for FIG. 2 is a reduced pipe (8) having a Diameter of 0.555 ft (Ref 7)

The pressure at Pipe (8) could be summarized by a pressure requirement of 2054819 or 298 psi (Ref 8). (Ref 8) solves for kinetic friction of 242 psi occurring due to depth of (11) as force through (8) having a diameter of 0.555 ft.

### Third Primary Mode Uses Water Ejectors

FIG. 3 illustrates a pipe charged to 4 bars of pressure that embodies ejector nozzles to increase velocity from pressure operating at a depth between 50 ft to 1000 ft depending on the design and pressure of water due to depth that enters the ejector piping system can be sequenced by the mode.

(11)(13)(2)(3)(14)(5)(7)(11), in FIG. 3, (11) describes a water body depth of 322 ft (Ref 1). (13) describes the water path, (2) describes the intake, (3) describes the enclosure housing the piping path which the pressure of (11) will take to (14) which describes a series of water ejectors connected hermetically to (5) which describes a series of turbine type electrical generators, and (6) which describes a series of pipes that return the water path to (11), Electrical Conductivity is made possible by (4) to a surface platform (9) for use by (8) being energy storage battery banks. (10) describes the use of water ejector from deep ocean energy production as an AC implementation. (12) describes a marine mammal near the marine protection zone (1).

An example of how purposing water ejectors with deep ocean energy production is provided herein by use of 12 Ejectors having a 7.48 gal per min per individual ejector pressure of 140 PSI at a depth of 322 ft (Ref 1). A combined horsepower from 12 ejectors at 140 psi×7.48 gallons per ejector per minute=733 horsepower (hp), thus; 7.33×745 watts=5.5 kW per minute (Ref 3). Similarly, 12 ejectors having 140 psi account for 327.72 kW per hour, or 2,871 MWH annually while operating continuously.

A power load and supply example of ejector efficiency from deep ocean energy production as applied to a close proximity electrical AC or DC power load, e.g. a residential community that consumes on average 10,500 kWh per year per home (Ref 27) and further provides for a continuous AC energy supply of 2,871 MWH of AC energy supply, or employ a series of DC energy storage battery banks to further power adjacent residential communities or employ as a business model for community development and future commerce, could power 273 residential homes (Ref 42). Similarly, a 6,500,000 MWH energy demand would require 2,264×12 ejector deep ocean energy production systems, (2,264×2,871 MWH=6,500,000 MWH. The ejector may be oversized sized to increase the volume of water flow (gallons per minute) to a turbine generator to allow for more energy production to reduce the number of water ejectors and turbine generators. Furthermore, the total marine area for 6,500,000 MWH would be 42 ft by 660 ft in length, or 27,720 square feet (Ref 43) at a water depth of 322 ft, but could be more or less depending on the power demand and application.

Furthermore, a series of reaction type turbines (5) wired in a parallel circuit and hermetically sealed could power an induction type motor having a horsepower rating of 7.40 horsepower for every 12 ejectors.

### Explanation of FIG. 4

(1) Is a marine type protection area, (2) is a filter and intake pipe, (3) is an enclosure capable of water submersion, (4) is a sub-marine cable, (5) is a turbine generator, (6) is a tailrace piping arrangement, (7) is a lower tailrace outfall, (8) is a second mid-level filter and intake, (9) is a stabilizer, (10) is an Anchor, (11) is a Water body, (12) is surface platform, (13) are energy storage battery banks, (14) is a mooring line.

### Explanation of FIG. 5

(1) Is a marine type protection area, (2) is a filter and intake pipe, (3) is an enclosure capable of water submersion, (4) is a sub-marine cable, (5) is a turbine generator, (6) is a tailrace piping arrangement, (7) is a lower tailrace outfall, (8) is a hollow empty pipe leading to the surface platform, (9) is a stabilizer, (10) is an Anchor, (11) is a Water body, (12) is surface platform, (13) are energy storage battery banks, (14) is a mooring line. (15) is a surface platform opening for a pipe, (16) Combined Water and Air path.

What is claimed is:

1. A water pressure energy production system comprising: a plurality of water intakes positioned in an upward, transverse or downward manner in direct fluid communication with a plurality of hydro turbines each with an associated electrical power generator:
a plurality of electrical power storage devices
a plurality of draft tubes disposed at a water exit of hydro turbine
a plurality of vacuum compartments in fluid communication with the positive pressure draft tubes
a plurality of secondary hydro turbines disposed at a region between the positive and negative pressure compartments

2. The water pressure energy production system of claim 1, wherein the system is configured to produce electrical energy at water depths ranging from about 100 feet to about 5000 feet of a body of water, but may be more.

3. The water energy production system of claim 1, wherein the hydro turbine is either:
an inward flow reaction type suitable for low water heads where the water flow is higher and its flow rate is adjustable;
or;
an inward radially and outward flow axial type suitable for low water heads where the water flow is higher and its flow rate is adjustable.

4. The water energy production system of claim 1, wherein the secondary hydro turbines are disposed at an alternative region or lowest region of the positive or negative pressure compartment.

5. The water energy production system of claim 1, wherein the system is configured to produce electrical energy at water depths ranging from 100 feet to 5000 feet or more and is con figured for closed loop pressurized internal continuous cycle operation which is placed in a bored hole in the earth that has been filled by water.

6. The water energy production system of claim 1, wherein the system comprises of suspension cables or has a means for being secured to the seafloor.

7. The water pressure energy production system of claim 1, wherein the system provides a means for protecting surrounding sea life.

8. The water energy production system of claim 1, wherein the system may be operated remotely or manually.

9. The water energy production system of claim 1, wherein the system provides for an air intake providing vacuum negative pressure.

10. The water pressure energy production system of claim 1, wherein an air turbine is placed within the air intake.
